(19) United States
(12) Patent Application Publication
(10) Pub. No.: US 2010/0178559 A1
(43) Pub. Date: Jul. 15, 2010

(54) NICKEL-COPPER CLAD TABS FOR RECHARGEABLE BATTERY ELECTRODES AND METHODS OF MANUFACTURING

(76) Inventors: Ou Mao, Pleasanton, CA (US); Eugene Tritenichenko, Palo Alto, CA (US); Yali Tang, Pleasanton, CA (US); Dania Ghantous, Walnut Creek, CA (US)

Correspondence Address: WILSON, SONSINI, GOODRICH & ROSATI, 650 PAGE MILL ROAD, PALO ALTO, CA, 94304-1050, US

(21) Appl. No.: 12/353,949

(22) Filed: Jan. 14, 2009

(51) Int. Cl. H01M 4/02; H01M 4/04

(52) U.S. Cl. 429/211; 29/623.5

(57) ABSTRACT

The invention provides nickel-copper clad tabs for rechargeable battery negative electrodes and methods of manufacturing thereof. Systems and methods for configuring tabs on a rechargeable battery may include a current collector comprising one or more collector foil and one or more tabs connected to the collector foil for conveying generated current from the current collector. The tabs may be configured to extract greater capacity from the battery electrodes so that the resulting battery may exhibit higher performance. The tabs may be configured so that a negative electrode tab may be clad with a nickel layer and a copper layer.

### BACKGROUND OF THE INVENTION

The battery performance of rechargeable lithium batteries depends on characteristics of electrodes used by the batteries. Battery cells have been made by bonding tabs to current collectors, such that the tabs are capable of conveying current from a current collector. Some examples of such cells may include a rectangular-shaped cell in which a plurality of rectangular-shaped electrodes are laminated or stacked; or a cylindrical-shaped cell in which band-shaped electrodes are spirally-wound. For instance, a spirally-wound lithium battery may include a positive electrode made by coating a band-shaped collector foil with a positive electrode active material, one or more tabs bonded to a part of the positive electrode, a separator, and a negative electrode made by coating a band-shaped negative collector foil with a negative electrode active material and one or more tabs superimposed on the positive electrode by way of the separator and a second separator imposed on the top of the assembly. These components may be wound integrally in a spiral manner. Tabs may be bonded to an electrode by methods such as ultrasonic welding, resistance welding, laser welding, stamping, riveting, or crimping.

Batteries have included tabs made by using a metallic foil, which has been attached to each of the positive and negative electrodes. A current could flow in each of the tabs when the battery is discharged or recharged. A tab can be attached at a leading end of a wound band-shaped electrode, at a trailing end thereof, or at a point between the leading end and trailing end thereof. Traditionally, tabs for negative electrodes have been formed of nickel. When the temperature of a tab increases during use, the electrical resistance within a tab can rise, reducing the output voltage of the battery and current flow through the tab. This translates to resistance or impedance that may hamper battery performance.

Therefore, a need exists for tab composition or configurations that may lead to reductions of battery resistance and impedance in order to increase the performance of the battery.

### SUMMARY OF THE INVENTION

The invention provides systems and methods for configuring electrode tabs for rechargeable batteries. Such configurations may include tab configurations and compositions. Various aspects of the invention described herein may be applied to any of the particular applications set forth below or for any other types of batteries and electricity generator elements. The invention may be applied as a standalone system or method, or as part of an integrated battery or electricity generation system. It shall be understood that different aspects of the invention can be appreciated individually, collectively, or in combination with each other.

An aspect of the invention provides for a battery comprising at least a positive electrode and a negative electrode, each with a current collector. A current collector may have at least one tab electrically connected to the collector foil. The tab of a negative electrode may be directly connected to a negative collector foil. The negative electrode tab may be a nickel-copper clad tab.

In some embodiments of the invention, a coating may be formed on the surface of a collector foil. The coating may include active materials, and may be coated on one or both surfaces of the collector foil. In some other embodiments of the invention, the electrodes and separators may be arranged in a number of different ways. Separators may be disposed between electrodes to prevent electrodes from coming into contact with one another. For instance, the current collector assembly may be laminated so that the negative current collector surface may be flush to the positive current collector and any separators.

One or more tabs may be electrically connected to each of the current collector foils. The tabs may be connected by methods such as fixedly welding the tabs to the current collector foil through means such as ultrasonic welding, laser welding, or resistance welding, or by stamping, riveting, or crimping the tabs onto the current collector foil. In other embodiments, the tabs may be connected to the uncoated portions of the foils.

In one embodiment of the invention, a tab may be connected to a current collector foil so that the tab may protrude from the current collector. The tab may protrude from the current collector along one side such that the length of the tab is substantially orthogonal to the length of the current collector. In this implementation, the length of the tab may be greater than the height of the collector foil so that the tab covers the entire or more than 75% of the height of the collector. In another embodiment of the invention, the tab may cover 25% to 75% of the collector height.

Tabs may be arranged at different intervals along the length of a current collector. In one embodiment of the invention, a negative electrode tab may be connected to a negative collector foil at one end and a positive electrode tab may be connected to a positive collector foil at the other end.

A negative electrode tab may be a nickel-copper clad tab. The negative electrode tab may include a nickel layer and a copper layer. In some embodiments, the copper layer may directly contact the negative collector foil and the nickel layer may directly contact the copper layer and not the negative collector foil. In some embodiments, the copper layer may be thicker than the nickel layer.

A negative electrode tab may be formed of any materials (which may include metals or alloys), compositions, or stacks thereof, which may have a reduced electrical resistance or reduced impedance as compared to a traditional Ni negative electrode tab. The copper layer and/or nickel layer thickness may be selected to result in a desired resistance or total impedance for a battery cell.

In some embodiments of the invention, a battery may be formed with a plurality of current collectors that are arranged in a stack. In some other embodiments, a band-shaped current collector can be spirally wound so that the side of the band-shaped electricity collector may result in a flush wound end surface, such as a jellyroll configuration to form a battery.

Another aspect of the invention may be directed to methods of manufacturing the negative electrode with nickel-copper tab and a battery including an electrode with the nickel-copper tab. For example, a method of manufacturing a negative electrode for use in a battery may comprise providing a current collector foil, coating at least a portion of the surface of the current collector foil, and electrically connecting a tab formed of a copper layer and a nickel layer to the current collector foil. The thickness of the copper layer and nickel layer may be selected to provide a desired battery impedance or resistance.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a negative electrode and a positive electrode arrangement.

FIG. 2 shows a Ni/Cu clad tab for an anode in accordance with one embodiment of the invention.

FIG. 3 shows a Ni/Cu clad tab attached to an anode collector in accordance with an embodiment of the invention.

FIG. 3A shows an example of a nickel-copper tab protruding from a substrate

FIG. 3B shows an example of a nickel-copper clad tab, where the layers are clad as an overlay.

FIG. 3C shows an example of a tab where a copper layer is sandwiched between two nickel layers.

FIG. 3D shows an example of a tab where a copper layer may be sandwiched between two stainless steel layers, which may be sandwiched between two nickel layers

FIG. 4 shows cell impedance upon 35 A pulses of a battery comprising a lithium-cobalt-oxide cathode and an anode for a new tab and for an old tab.

FIG. 5 shows cell impedance upon 35 A pulses of a battery comprising a lithium-nickel-manganese-cobalt-oxide cathode and an anode for a new tab and for an old tab.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

Rechargeable batteries, such as lithium ion rechargeable batteries, may include negative electrodes with nickel-copper clad tabs in accordance with one aspect of the invention. Batteries may include electrode tabs of multiple materials, or stacks of materials, that may provide reduced resistance or impedance as compared to traditional electrode tabs, which may result in improved battery performance.

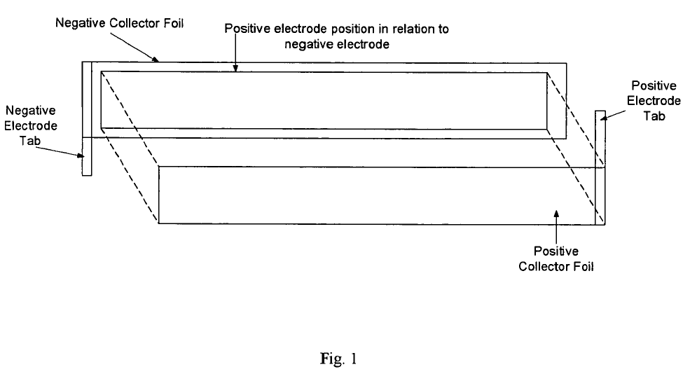

An embodiment of a galvanic cell (which may also be referred to herein as a battery or cell) can comprise the following components: one or more positive electrodes and one or more negative electrodes, and one or more separators to separate the electrodes. Each electrode may consist of a current collector foil piece with a coating comprising an active material. The current collector foil pieces may include one or more tabs attached to it. The tabs may be connected to collector foils in various configurations and may be formed of various materials, and the components may be combined to form a battery. FIG. 1 shows an example of a negative electrode including a negative collector foil and negative electrode tab, as well as a positive electrode including a positive collector foil and positive electrode tab.

The various components of a battery can be made of different materials known in the art or later developed. In accordance with various embodiments, the collector foils of an electrode, the tabs of an electrode, the coating including active material which may be applied to the collector foil, and the separators can comprise different materials.

In some embodiments of the invention, the collector foil may be made of materials capable of conducting electrical current, such as a metallic foil. For example, the metallic foil can be made from a material, such as copper, aluminum, nickel, titanium, or stainless steel. The collector foil may also include clad materials (e.g., clad materials with copper and aluminum, clad materials with nickel and aluminum, clad material with stainless steel and aluminum, or plated material comprising a combination of materials), or layers of materials. In some embodiments of the invention, the negative and positive collector foils may be made of different materials. For example, a negative collector foil may be formed with copper and a positive collector foil may be formed of aluminum. Alternatively, the negative and positive collector foils may be formed of the same material.

The tab for the positive or negative electrode can include any material known or later developed in the art. The tab materials will be discussed in greater detail below.

In some embodiments of the invention, a coating comprising an active material may be formed on the surface of a collector foil. The coating may be coated on the front surface of a collector foil, the back surface of the collector foil, or both surfaces of the collector foil. The coating including the active material may cover a part of the surface or the entire surface of the foil. The coating may continuously or non-continuously cover parts of the surface of the collector foil. The coating may or may not cover portions of a collector foil where a tab may be connected to the collector foil. The current collector coating may include active materials mixed with one or more conductive agents that may enable current flow.

For example, a positive collector foil may be covered with a coating including an active material such as lithium-based oxide, a binder, and a conductive material. In some embodiments, the coating for the positive electrode can be a mixture of a powder of lithium transition metal oxide, a conductive powder, and a binder agent. The lithium transition metal oxide can be materials such as lithium cobalt oxide (LiCoO₂), lithium nickel oxide (LiNiO₂), lithium manganese oxide (LiMn₂O₄), or a material wherein other elements, preferably lithium, magnesium, aluminum, or other group 3d or 4d transition element may be added to or partially substituted for the crystal of the active material. The binder may not be particularly limited. Several examples of binders may include polytetrafluoroethylene (PTFE), polyvinylidene fluoride (PVDF), or a non-fluorinated binder, such as ethylene-propylene-diene copolymer (EPDM), styrene-butadiene rubber (SBR), and carboxymethylcellulose (CMC). Preferable conductive agents usable may include carbon black, acetylene black, KETJEN BLACK, Super-P, PureBlack, vapor growth carbon fibers (VGCF), natural graphite, synthetic graphite, or expanded graphite. In some embodiments, the conductive agents may be a blend of the above. In some embodiments, the mixture can be turned into a slurry by adding solvents, and the positive collector foil can be coated with the slurry. The solvents may include N-Methylpyrrolidone (NMP), Dimethylformamide (DMF), Polyvinyl alcohol (PVA) or water.

A negative collector foil may be covered with a coating including an active material selected from the group consisting of carbon material, and a binder. However, it may be understood that such materials coated on the collector foil may include other materials known or later developed. In some embodiments, the coating for the negative electrode can be a mixture of a powder of carbon and a binder agent. The active material may include a material which can occlude and devolatilize lithium ions, for example, carbonaceous materials or chalcogen compounds, and those formed of a light metal. For example, such carbonaceous materials may include coke, carbon fibers, pyrolysis vapor growth carbonaceous materials, graphite, resin sintered products, and mesophase pitch carbon fiber or mesophase spherical carbon sintered products. Chalcogen compounds may include titanium disulfide (TiS₂), molybdenum disulfide (MoS₂), niobium selenide (NbSe₂), or transition metal oxides of low valence such as CoO. Examples of preferred light metals or other metals may include aluminum, aluminum alloys, magnesium, magnesium alloys, silicon, silicon alloys, tin and tin alloys, lithium metal, and lithium alloys. The binders may include, for example, polytetrafluoroethylene (PTFE), polyvinylidene fluoride (PVDF), ethylene-propylene-diene copolymer (EPDM), styrene-butadiene rubber (SBR), and carboxymethylcellulose (CMC). The mixture can be turned into a slurry by adding solvents, and the negative collector foil can be coated with the slurry. The solvents may include N-Methylpyrrolidone (NMP), Dimethylformamide (DMF), Polyvinyl alcohol (PVA) or water.

A coating including an active material may be applied to a collector foil. The coated collector foil may be dried, in some embodiments by applying heat or infrared (IR) radiation.

The positive and negative collector foils may have coatings applied and pressed on them such that the positive and negative electrodes may have various porosities. The positive and negative electrodes may have a porosity from approximately 5% to 80%. In some embodiments, the positive and negative electrodes may have different porosities. For example, a positive electrode may have a 40% porosity, while a negative electrode may have a 45% porosity. In alternate embodiments, the positive and negative electrodes may have the same porosity.

In some other embodiments of the invention, a battery may also comprise separators, and electrodes and separators may be arranged in a number of different ways. The electrodes may be separated by one or more separators between them so that the separators may be disposed between a positive electrode and a negative electrode. In some embodiments, one or more separators may be disposed adjacent to a positive electrode or negative electrode.

The separators may be made of a material that may separate the electrodes while allowing ions to pass through. For example, the separator may be a very thin sheet of microporous plastic. Alternatively, the separator may be formed of a material, which may be impregnatable with an electrolyte and may be permeable to lithium ions, such as a nonwoven fabric of a synthetic resin, a porous film of polyethylene, a porous film of polypropylene, or polyether of the PEO-PPO copolymer type of the 3 branch or 4 branch type. A separator may be prepared by being cross-linked by thermal heating, E-Beam, IR, or UV.

In one example, a battery may be prepared by taking dried positive and negative electrodes so they face one another through a separator, layering an additional separator, winding them into a roll, inserting the roll into a battery casing, and adding an electrolyte.

A current collector may have a number of shapes and sizes. For instance, the current collector foil may be rectangular in shape and with a particular height, length, and thickness. Similarly, the current collector foil may be band-shaped, which may be similar to a rectangle where the length far exceeds the height and thickness. Alternatively, the current collector foil may have any shape or configuration that may allow it to function within a battery. Current collector foils may be selected with predetermined thicknesses that may enable a battery to exhibit a higher performance.

Electrode Tabs

One or more tabs may be electrically connected to the current collectors. The tabs may also be of various shapes or sizes. In one embodiment of the invention, the tabs may be comprised of rectangular strips. The tabs may be formed of any dimensions. In one embodiment, a tab may be about 15 mm long, 4 mm wide, and 0.10 mm thick.

The tabs may be connected by methods such as fixedly welding the tabs to the current collector foil through means such as ultrasonic welding, resistance welding, or laser welding. An ultrasonic process may be advantageous because it may be less likely to cause thermal influence. It may also enlarge the bonding area and reduce contact resistance. Tabs may also be brazed or soldered to the current collector foil. Alternatively, the tabs may be connected to the current collector foils by stamping, riveting, or crimping the tabs onto the current collector foil or by taping the tabs to the current collector foil. Some tab portions may be attached to the current collector foil by being deposited or plated onto the foil, or by use of an adhesive. Some alternate embodiments of the invention provide for tabs made from the current collector foils themselves, such as by slitting and folding the foils or otherwise cutting or shaping them from the foil. Any combinations of these methods may be used.

As discussed previously, the tab for the positive or negative electrode can include any material known or later developed in the art. For example, a positive electrode tab or negative electrode tab may include the same metallic foil as that of the collector foil for the positive or negative electrode, respectively and be electrically connected to the collector foil. In some embodiments, the tab may be part of the same metallic foil of the collector foil itself, or may include a component formed from the collector foil. Alternatively, the tab can be made of a different metallic foil. Materials for the tabs may include metallic foils such as a copper, aluminum, nickel, titanium, or stainless steel, or alloys thereof. Tabs may also include multiple metallic foils or materials which may be arranged in any manner including, but not limited to, stacks of two or more materials. Tabs may also include materials that have been clad or plated with additional materials. In some embodiments of the invention, tabs may be formed of different materials from one another.

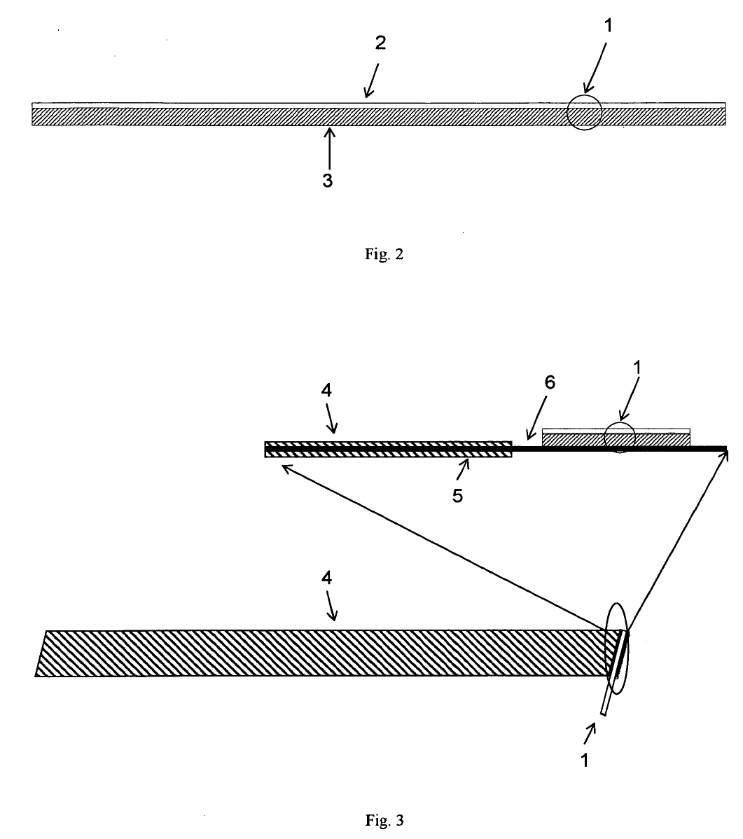

FIG. 2 shows an example of a nickel-copper clad tab for a negative electrode, in accordance with a preferable embodiment of the invention. A nickel-copper clad tab 1 may include a nickel (Ni) layer 2 and a copper (Cu) layer 3. The nickel layer may be formed of pure nickel or nickel alloy and the copper layer may be formed of pure copper or copper alloy. The nickel and copper tab layers may have any thickness.

For example, in some embodiments, the nickel layer of the nickel-copper clad tabs may be about 0.001″ or 0.025 mm thick, and the copper layer of the nickel-copper clad tabs may be about 0.003″ or 0.075 mm thick. The copper layer may be thicker than the nickel layer. In some instances the copper layer may be about three times thicker than the nickel layer. The nickel layer may have any thickness n and a copper layer may have any thickness around 3×n.

In other embodiments, the thickness of the nickel layer and the copper layer may have any relationship. For example, in alternate embodiments, the nickel layer may be thicker than the copper layer. Or the copper layer may be thicker than the nickel layer by a factor other than three, such as a factor falling between one and ten.

In some embodiments of the invention, the layers may have a uniform or substantially uniform thickness along the length or width of the tab. In other embodiments, the thicknesses of the layers may vary depending on the part of the tab.

The nickel layer and copper layers may cover the same area of the tab. For example, the nickel and copper layers may cover the entirety of the tab area. In other embodiments, the nickel and copper layers may cover a portion of the tab area. Alternatively, the portions covered by nickel and copper may coincide, while in other embodiments, a portion of a tab may have a nickel layer and a portion of a tab may have a copper layer which may or may not overlap.

In a preferable embodiment of the invention, the cladding may occur along the entire length of the tab. Thus, a tab may have one or more nickel layer and one or more copper layer along the entire length of the tab.

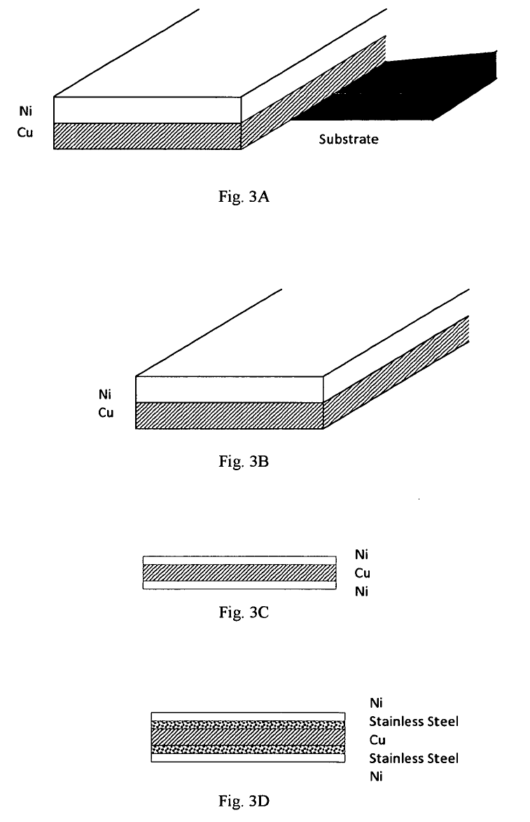

The tab may be formed of a nickel layer and a copper layer and may be in contact with the substrate. A portion of the tab may protrude from the substrate. The portion of the tab that may protrude from the substrate may include nickel and copper, and need not have a substrate supporting the tab. For example, FIG. 3A shows an example of a nickel-copper tab protruding from a substrate, with a copper tab layer and a nickel tab layer.

In some embodiments, the tab may be formed using any methods of manufacturing known or later developed in the art. See, e.g., “A Guide to TMI Clad Materials”, http://www.technicalmaterials.com/products/TMI_{—}364_Clad_Brochure.pdf, (accessed Jan. 6, 2009), which is hereby incorporated by reference in its entirety. For example, nickel and copper may be bonded by direct contact of their surfaces. The surfaces may be cleaned. A nickel layer and copper layer may be bonded using a direct bonding method, such as a roller mill of high vacuum and high temperature. Any other direct bonding methods known in the art may be used. The nickel and copper layers may form a roll or sheet, which may be slit to the final tab dimensions. In some embodiments, the tab may be a laminate including one or more nickel layer and one or more copper layer.

In one implementation, a clad inlay or overlay process may include the steps of: (1) cleaning, (2) skiving, (3) bonding, (4) heat treating, (5) rolling to temper, (6) slitting, and (7) leveling. In a preferable embodiment of the invention, an overlay process may be used. Before the cladding process begins, the metal surfaces may be cleaned to remove contaminants. In instances where clad inlay is occurring, a groove may be cut out of a base metal to a precise depth and width to match the inlay strip. For inlays, the metal to be inlayed may be fed into the base metal groove and passed through a bonding mill, which may exert a sufficient pressure to force the metal surfaces into contact and establish a bond. For overlays, pressure bonding may be used to produce multiple layers of metals of the same width. The metals may be subjected to heat treatment, which may promote diffusion between the metals, resulting in a metallurgical bond. Additional rolling may be provided to create a final reduction of the metal thickness, to produce a specified temper and/or thickness as desired. The strip may then be cut to specified dimensions. Additional flattening and straightening may be achieved by a combination of tension and bending over a series of rolls.

The layers, which may include nickel and copper layers, may be clad as an overlay, such as the arrangement shown in FIG. 3B. Alternatively, other possible configurations may be included, such as those provided by FIGS. 3C and 3D. FIG. 3C shows an example where a copper layer is sandwiched between two nickel layers. FIG. 3D shows an example where a copper layer may be sandwiched between two stainless steel layers, which may be sandwiched between two nickel layers. As discussed elsewhere, any number or materials of layers may be provided. Such examples may show instances where a tab is clad of materials forming an overlay. Similarly, a tab may be a laminate formed of a plurality of layers.

In another implementation, a layer may be formed onto other layers by coating methods, such as electrolytic plating or dip coating in a molten metal, for example, molten Al.

In additional alternate embodiments of the invention, an electrode tab (whether for a negative or positive electrode) may include two or more layers that may be formed of any material. For example, any discussion herein of the nickel and copper layers could apply to layers of other materials (such as metals or alloys thereof). Thus any discussion of nickel-copper clad tabs may apply to tabs of other materials. Furthermore, although two layers may be discussed in an exemplary embodiment, such discussions may apply to any number of layers. An electrode tab may be clad with any materials that may form two or more layers, such that the layers have any thickness or configuration. For instance, a tab may comprise a first layer and a second layer. The first layer may directly contact a substrate and the second layer may directly contact the first layer, and the thickness of the first layer may exceed the thickness of the second layer, be equal to the thickness of the second layer, or be less than the thickness of the second layer.

An electrode tab may include layers, such as nickel and copper that may exhibit a resistance lower than the resistance of a traditionally used tab, such as a nickel tab. An electrode tab may also have any configuration or composition that may give it an impedance that is lower than the impedance of a traditional tab. The materials forming the layers of the electrode tab and/or the thickness of the layers of the electrode tab may be selected to provide a desired total resistance or total impedance for a battery.

FIG. 3 shows a nickel-copper clad tab attached to an anode collector (which in some instances may be a negative electrode collector) in accordance with an embodiment of the invention. FIG. 3 shows a perspective view of the anode collector as well as a zoomed-in side view of the end of the anode collector including a tab. An anode 4 may include an anode coating 5 and a substrate 6. In some embodiments, the anode substrate may be a negative collector foil. As discussed previously, an anode coating 5 may be applied to both sides of a substrate 6.

An anode 4 may have any thickness known or later developed in the art. For example, an anode 4 may be approximately 0.115 mm thick. The substrate 6 of the anode may be approximately 0.015 mm thick, and each anode coating 5 may be about 0.05 mm thick. An anode and any of its components such as substrate and layers may have any thickness which may or may not be approximately proportional to the example discussed. For example, each anode coating may or may not be of the same approximate thickness.

A nickel-copper clad tab 1 may be connected to the anode by contacting the substrate 6. In a preferable embodiment, the tab may directly contact the substrate, without contacting an intermediate coating. In some embodiments, a copper layer 3 of a nickel-copper clad tab 1 may directly contact the substrate 6. The nickel layer 2 of a nickel-copper clad tab 1 may directly contact the copper layer 3, but not the substrate 6. In other embodiments, the layers may be reversed such that a nickel layer directly contacts the substrate while the copper layer does not. In some instances, the tab may be oriented such that both the nickel and copper layers or portions thereof may directly contact the substrate.

A nickel-copper clad tab 1 may contact a substrate 6 such that a portion of the substrate is exposed on either side of the tab. For example, as shown in FIG. 3, a portion of an anode may include coating and a portion of the substrate may be exposed. A tab may be placed on the exposed substrate such that the exposed substrate remains on either side of the tab. Thus when describing an anode along the length of the anode: a coated portion of an anode may be provided, then exposed substrate, then a tab on the substrate, and then additional exposed substrate. In other embodiments, no portions of the substrate may be exposed or other portions of the substrate may be exposed. For example, a tab may be at the end of an anode such that no substrate extends beyond the tab. Or a tab may be immediately adjacent to an anode coating such that no substrate is exposed between the coated portion of the anode and the anode tab.

A tab need not be placed at the end of an anode. The tab may be placed anywhere along the length of the anode. Regardless of where the tab is placed along the anode, there may be exposed substrate adjacent to the tab on both sides of the tab, on one side of the tab, or on neither side of the tab.

In other embodiments, the nickel-copper clad tabs may be connected to the non-coated portions of the anode, which may be a portion of the anode which is not coated with an active material. A substrate may be provided with a non-coated portion on a side, and the tabs may be attached to the non-coated portion. The non-coated portion may be prepared in advance in a coating process for the coating including the active materials. Alternatively, the tabs can be bonded to the substrate from above the coating, although such an operation may generate dust, and may result in a decreased bonding strength between the tab and the substrate, or increased resistivity or impedance.

A nickel-copper clad tab 1 may be located on one side of the substrate, as shown in FIG. 3. In other embodiments, the tab may be located on the other side of the substrate. Alternatively, the tab may encompass both sides of the substrate. For example, a nickel layer may be on one side of the substrate and the copper layer may be on the other side of the substrate. Or a copper layer may directly contact the substrate on both sides and a nickel layer may be on one or both sides of the copper layer. In some alternate embodiments, the tabs may be embedded within the substrate or may be connected through the substrate so parts of the tabs may be connected at one side and part may be connected at the other side.

If the tab is connected on one side of the substrate, the other side of the substrate may or may not include coating.

As discussed, a tab may have any shape, configuration or geometry. In a preferable embodiment, a nickel-copper clad tab may be connected to a current collector foil so that the tab may protrude from the current collector (which may preferably be a current collector for a negative electrode, but may also apply to positive electrodes). In one implementation, a tab may be connected to the current collector foil so that the length of the tab may be parallel to the end of the collector foil, which may result in the length of the tab being orthogonal or substantially orthogonal to the length of the current collector. In this implementation, the length of the tab may be greater than the height of the current collector so that the tab may cover the entire height or more than 75% of the height of the current collector, and may protrude beyond the height of the current collector (e.g., as shown in FIG. 3). In other implementations, the length of the tab may not cover the entire height of the current collector but may still protrude beyond the height of the current collector.

In one implementation, a tab may protrude beyond the height of a collector foil so that it only protrudes on one side. For example, if the collector foil was 2 cm in height, and the tab was 3 cm in length, 2 cm of the length of the tab may cover the collector foil and 1 cm of the tab may protrude from the collector foil.

In an alternate implementation, the tab may protrude beyond the height of the collector foil so that it may protrude on two sides. For example, if the collector foil was 2 cm in height, and the tab was 3 cm in length, 2 cm of the length of the tab may cover the collector foil and 1 cm of the tab may protrude from the collector foil, such that 0.5 cm of the tab may be protruding in one direction and 0.5 cm of the tab may be protruding in the opposite direction. Alternatively, the tab may not have to protrude in a symmetrical amount, so for example, 0.25 cm of the tab may be protruding in one direction while 0.75 cm of the tab may be protruding in another direction.

In an alternate embodiment of the invention, a tab may be connected to the current collector foil so that the tab may be symmetrically arranged along the center line of the foil with respect to height. In such a case, a shorter tab can be used if it is connected symmetrically at the half height of the collector. A tab of any length may be used as long as it is symmetric about the y-axis of the collector foil. For example, if the collector foil was 2 cm in height, and the tab was 1 cm in length, the tab may be attached to the foil so that it is symmetric about the y-axis, so that 0.5 cm of foil could be beyond the tab at either end.

A tab may have any orientation. For example, the length of the tab may be parallel to the length of the collector foil, or may be at a 30, 45, or 60 degree angle to the length of the collector foil.

In some embodiments, one tab may be connected to a current collector foil at an end of an electrode. In other embodiments, any number of tabs may be connected to a current collector foil of an electrode at any location along the electrode. One or more of the tabs may be nickel-copper clad tabs. The tabs may all have substantially the same configuration, or may vary.

The use of a nickel-copper clad tab may result in significantly better conductivity than a commonly used nickel tab material (either pure nickel or the commonly used Ni 200 alloy). By replacing a traditional Ni tab of an anode with a highly conducting Ni/Cu tab, cell impedance may be lowered and cell performance at high rate/power may be significantly improved.

One aspect of the invention may provide a battery that can be formed of two or more electrodes, where a negative electrode may include at least one Ni/Cu tab in accordance with one aspect of the invention. The electrodes may have a coating and may be arranged with separators in a number of different arrangements. The battery may be a rechargeable battery. In some implementations, the battery may be a lithium ion battery.

In some embodiments of the invention, a battery may be formed with a plurality of electrodes that are arranged in a stack. Such stacks may be arranged so that there can be alternating layers of a positive electrode with at least one tab, a separator, a negative electrode with at least one tab, another separator, and then repeating. The tab of the negative electrode may be a Ni/Cu clad tab. Such stacks of electrodes may incorporate any of the tab configurations and combinations thereof discussed herein.

In some other embodiments, a band-shaped electrode can be laminated by winding itself spirally so that the side of the band-shaped electrode results in a flush wound end surface, in a jellyroll configuration to form a battery. Such bands may be of different dimensions such as lengths and thicknesses and heights, which may result in a battery in a jellyroll configuration of varying diameters. For instance, spiral-wound jellyroll batteries may have diameters ranging from 0.1 mm to 10 cm. Batteries may have diameters of approximately 0.1 mm, 1 mm, 5 mm, 10 mm, 17.4 mm, 26 mm, 31 mm, 41 mm, 50 mm, or 10 cm. In some embodiments of the invention, the jellyroll batteries may be circular in cross-section, or may be spirally wound with other cross-sections, such as ovals, rectangles, or any other shape. Spirally wound current collectors may incorporate any of the tab compositions, configurations and combinations thereof discussed herein.

In some embodiments of the invention, the battery may be a rechargeable battery such as a lithium ion battery, a lithium polymer battery, a nickel cadmium battery, a nickel metal hydride battery, or a lead acid battery. In some instances, the battery may have a cylindrical cell format, or a prismatic cell format, such as an 18650 cylindrical cell format, 26650 cylindrical cell format, 31650 cylindrical cell format, or 633450 prismatic cell format.

One aspect of the invention provides a method of manufacturing a negative electrode with a nickel-copper clad tab. The negative electrode may be used within a battery. The method may include providing a current collector foil, coating at least a portion of the surface of the current collector foil, and electrically connecting a tab formed of a copper layer and a nickel layer to the current collector foil. The tab may have any of the configurations or compositions discussed. The tab may be electrically connected to the current collector foil such that the copper layer may directly contact the current collector foil. The tab may be electrically connected to the current collector foil such that the nickel layer does not directly contact the current collector foil. Any methods known or later developed in the art for electrically connecting the tab to the current collector foil may be used.

Another embodiment of the invention provides a method of manufacturing a battery that may utilize a nickel-copper clad tab. The method may include selecting a negative collector foil and a positive collector foil, and selecting a negative electrode tab to be connected to the negative collector foil, with a copper layer with a first thickness (t1) and a nickel layer with a second thickness (t2). The thickness of the layers (t1) and (t2) may be selected to provide a customized total cell impedance or resistance for the battery. The copper layer thickness (t1) may be selected to be greater than the nickel layer thickness (t2). The copper layer thickness (t1) may be selected to be three times greater than the nickel layer thickness (t2) such that (t1)=3×(t2).

### EXAMPLE

A Ni/Cu tab that was 0.004″ thick and 4 mm wide was provided, as well as a traditional Ni tab that was also 0.004″ thick and 4 mm wide. The resistivity of the Ni/Cu tab was measured to be 2.0×10⁻⁶ Ω-cm (which is an apparent/average resistivity since the tab has two component materials), or 0.5 mΩ per cm of the 0.004″ thick and 4 mm wide tab. The resistivity of the traditional Ni tab is 7.3×10⁻⁶ Ω-cm, or 1.8 mΩ per cm of the 0.004″ thick and 4 mm wide tab. As a reference, an Al tab for a cathode has a resistivity of 2.8×10⁻⁶ Ω-cm.

By replacing the traditional (Ni) tab with a new (Ni/Cu clad) tab, the anode tab resistance may be reduced by 3.6 times. Assuming an effective anode tab length of 15 mm (where the anode tab length may include: a jelly-roll radius of 9 mm+separator edge clearance of 2 mm+4 mm to the first welding spot), it is estimated that the anode tab resistance is 2.7 mΩ for the traditional Ni tab and 0.7 mΩ for the Ni/Cu tab respectively, at room temperature.

Resistivity of metal increases with temperature. Copper has a temperature coefficient 0.0068 and nickel has a temperature coefficient of 0.0059. Joule heating under high current causes significant temperature rise of the cell and the tab. The cell outside temperature can reach 60° C. or higher, and the Ni tab itself can reach even higher temperatures.

Various cells were pulsed at 35 A. From the discoloring of the separator around the traditional Ni tab from cells opened after 35 A pulsing, it appears that the tab temperature reached above 140° C., at least temporarily during pulsing. The Ni/Cu tab remains at lower temperature than the old Ni tab due to less joule heating. Thus 100° C. (calculated as: cell temperature 60° C.+mid of the Ni tab temperature and cell temperature (140° C.−60° C.)/2) can be an effective reference point to estimate the benefit of using the Ni/Cu tab.

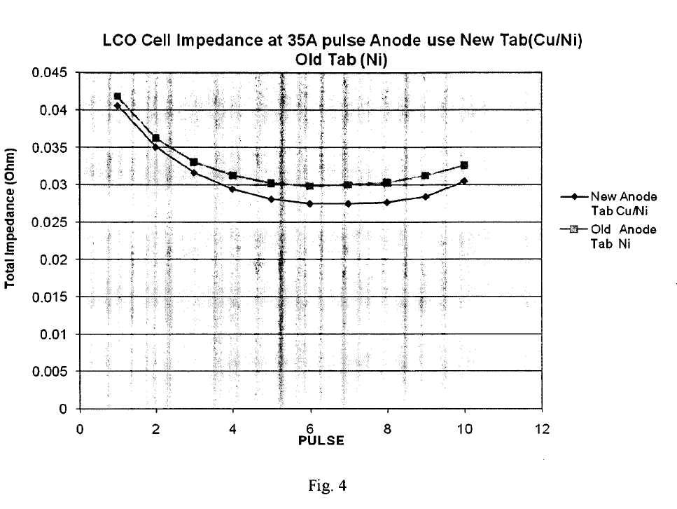

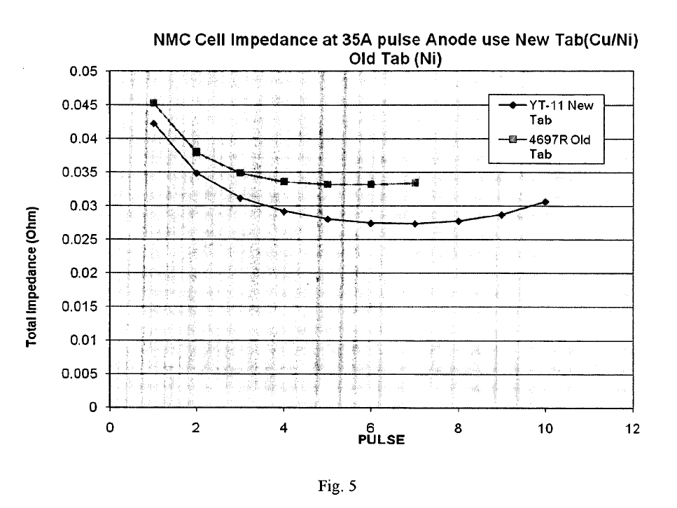

It is estimated that the anode tab resistance is 4.0 mΩ and 1.1 mΩ at 100° C. for the traditional Ni tab and the Ni/Cu tab respectively. Thus, using the Ni/Cu tab can lead to as much as 2.9 mΩ reduction in cell impedance, or 8%. As shown in FIG. 4 and FIG. 5, a total cell impedance may typically be about 35 mΩ.

FIG. 4 shows cell impedance upon 35 A pulses of a battery comprising a lithium-cobalt-oxide (LCO) cathode and an anode for a Ni/Cu tab and for a traditional Ni tab. FIG. 5 shows cell impedance upon 35 A pulses of a battery comprising a lithium-nickel-manganese-cobalt-oxide (NMC) cathode and an anode for a new Ni/Cu tab and for a traditional Ni tab. The cells underwent 10 second DC discharge pulse test conditions. The test conditions included 10 second pulses at a given current followed by 120 seconds of rest between each pulse. The number of pulses was used as an indication of the cell performance. The cells were tested with a pulse current setting of 35 A. FIG. 4 and FIG. 5 show that cells with the Ni/Cu tab may have lower cell impedance, thus delivering higher voltage and energy than the cells with the traditional Ni tabs.

In the case of the NMC cells, the new Ni/Cu tab can increase cell rate capability and the capacity at a high rate, so that a cell with the Ni/Cu tab may deliver significantly more pulses than a cell with the traditional Ni tab.

The benefit of using the Ni/Cu tab with low resistance will be more pronounced at high temperature. As seen in FIG. 4 and FIG. 5, the reduction of total cell impedance due to the use of a Ni/Cu tab can be more pronounced as the test proceeds and the cell temperature increases from room temperature to above 60° C. This may be because as temperature increases, the tab resistance increases while the electrochemical impedance, such as ion transport in electrolyte or solid, decreases so the contribution of the tab resistance to the total cell impedance may be more pronounced.

The concepts disclosed herein may be applied to other batteries or secondary batteries, such as those described in U.S. Pat. No. 5,851,698; U.S. Pat. No. 7,276,313; or U.S. Patent Application No. 2003/0194608, which are hereby incorporated by reference in their entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. An electrode for use in a battery comprising:
a tab protruding at least partway from the electrode,
wherein the tab is clad with a copper tab layer and a nickel tab layer.

2. The electrode of claim 1 wherein the copper tab layer is between 0.025 mm and 0.150 mm thick.

3. The electrode of claim 1 wherein the nickel tab layer is between 0.005 mm and 0.100 mm thick.

4. The electrode of claim 1 wherein the copper tab layer is 0.075 mm thick.

5. The electrode of claim 1 wherein the nickel tab layer is 0.025 mm thick.

6. The electrode of claim 1 wherein the copper tab layer is substantially three times as thick as the nickel layer.

7. The electrode of claim 1 wherein the copper tab layer directly contacts the current collector foil.

8. The electrode of claim 1, further comprising:
a current collector foil; and
a coating covering at least a portion of a surface of the current collector foil.

9. The electrode of claim 1 wherein the nickel tab layer does not directly contact the current collector foil.

10. The electrode of claim 1 wherein the current collector foil is formed of copper.

11. The electrode of claim 1 wherein the tab is located at one end of the current collector foil.

12. The electrode of claim 1 wherein the tab is adjacent to at least one exposed region of the current collector foil without the coating.

13. A battery comprising:
a pair of current collector foils including a negative collector foil and a positive collector foil; and
at least one tab electrically connected to the negative collector foil,
wherein the tab is formed of a copper layer and nickel layer, and the copper layer directly contacts the negative collector foil.

14. The battery of claim 13 wherein the nickel layer does not directly contact the negative collector foil.

15. The battery of claim 13 wherein the pair of current collector foils is rolled into a jellyroll configuration.

16. The battery of claim 13 wherein a plurality of current collector foils as described are arranged in a stack.

17. The battery of claim 13 further comprising at least one separator between the current collector foils.

18. The battery of claim 13 wherein at least one of the collector foils further comprises at least one coating including an active material.

19. A battery comprising:
a first current collector foil and a second current collector foil; and
at least one tab electrically connected to the first current collector foil,
wherein the tab comprises a first layer directly contacting the first current collector foil and a second layer directly contacting the first layer, and the thickness of the first layer exceeds the thickness of the second layer.

20. The battery of claim 19 wherein the first layer includes copper and the second layer includes nickel.

21. The battery of claim 19 wherein the thickness of the first layer is three times the thickness of the second layer.

22. The battery of claim 19 wherein the battery is a rechargeable lithium ion battery.

23. The battery of claim 19 wherein the tab protrudes from the current collector foil.

24. A method of manufacturing a negative electrode for use in a battery comprising the following steps:
providing a current collector foil;
coating at least a portion of the surface of the current collector foil with an active material; and
electrically connecting a tab formed of a copper layer and a nickel layer to the current collector foil,
wherein the copper layer directly contacts the current collector foil.

25. The method of claim 24 wherein the copper layer has a greater thickness than the nickel layer.

26. The method of claim 24 wherein the nickel layer does not directly contact the current collector foil.

27. A method of manufacturing a battery comprising the following steps:
selecting a negative collector foil and a positive collector foil; and
selecting a negative electrode tab to be connected to the negative collector foil, with a copper layer with a thickness (t1) and a nickel layer with a thickness (t2),
wherein (t1) and (t2) are selected thicknesses to provide a customized total cell impedance for the battery.

28. The method of claim 27 wherein (t2)>(t1).

29. The method of claim 27 wherein (t2)=3×(t1).
